(19) United States
(12) Patent Application Publication
(10) Pub. No.: US 2004/0094993 A1
(43) Pub. Date: May 20, 2004

(54) Sunshade assembly and vehicle comprising such a sunshade assembly

(75) Inventor: Leonardo Antonio Mathilde Jans, Venray (NL)

Correspondence Address: Steven M. Koehler, Westman, Champlin & Kelly, Suite 1600, 900 Second Avenue South, Minneapoils, MN, 55402-3319, US

(73) Assignee: Inalfa Roof Systems Group B.V., VENRAY (NL)

(21) Appl. No.: 10/712,754

(22) Filed: Nov. 13, 2003

(30) Foreign Application Priority Data
Nov. 18, 2002 (EP) 02079836.9

(51) Int. Cl. B60J 7/00

(52) U.S. Cl. 296/214

(57) ABSTRACT

A sunshade assembly for use in a vehicle comprises a flexible sunshade screen and two spaced, parallel guides for receiving and guiding two parallel lateral edges of the sunshade screen. Each of the lateral edges of the sunshade screen comprises loop-shaped provisions. Each guide comprises a longitudinal channel which opens towards the sunshade screen through a longitudinal slot. A core member is positioned in the channel and extends therein such, that between the core member and the surrounding guide a space is defined for slidingly receiving the loop-shaped provisions. The slot has a width which is smaller than the combined width of the core member with surrounding loop-shaped provisions.

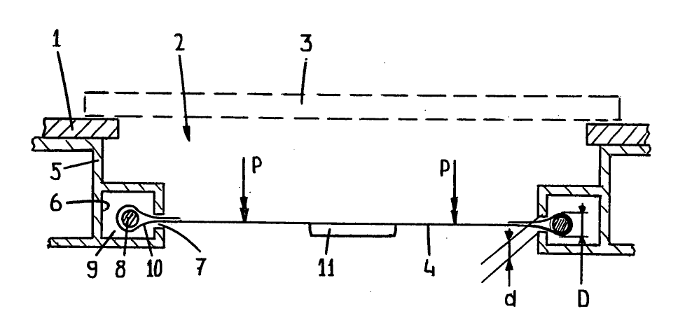

### BACKGROUND OF THE INVENTION

In a first aspect the present invention relates to a sunshade assembly for use in a vehicle, comprising a flexible sunshade screen and two spaced, parallel guides for receiving and guiding two parallel lateral edges of the sunshade screen.

On the one hand the cooperation between the guides and the lateral edges of the sunshade screen should be such, that the sunshade screen can move relative to the guides without too great an effort. On the other hand, however, it should be prevented that the lateral edges of the sunshade screen get disengaged from the guides, as well during a movement of the sunshade screen as during a stationary position thereof. A sliding movement of the sunshade screen often is obtained by manually engaging a forward edge of the sunshade screen and moving it in the desired direction. Such a manual engagement most times leads to eccentric forces acting on the sunshade screen, tending to distort it, which distortion leads to the lateral edges leaving the guides. In a stationary position of the sunshade screen external forces, such as wind pressure, also can lead to a distortion, with the same effects.

### SUMMARY OF THE INVENTION

It is an object of the present invention to provide an improved sunshade assembly, in which the above-mentioned drawbacks are eliminated in a simple, yet effective manner.

Thus, in accordance with one aspect of the present invention, there is provided a sunshade assembly for use in a vehicle, comprising a flexible sunshade screen and two spaced, parallel guides for receiving and guiding two parallel lateral edges of the sunshade screen, characterized in that each of said lateral edges of the sunshade screen comprises loop-shaped provisions or elements, whereas each guide comprises a longitudinal channel which opens towards the sunshade screen through a longitudinal slot, wherein a core member is positioned in the channel and extends therein such, that between the core member and the surrounding guide a space is defined for slidingly receiving the loop-shaped provisions, and wherein the slot has a width which is smaller than the combined width of the core member with surrounding loop-shaped provisions.

The space defined between the core member and the surrounding guide can be dimensioned such, that the loop-shaped provisions can be accommodated therein with a wide fit (while surrounding the core member), thus enabling an easy sliding movement of the sunshade screen relative to the guides. However, when a distortion of the sunshade screen occurs, the loop-shaped provisions are tightened around the core member. Because, however, the combined width of the core member with surrounding loop-shaped provisions is larger then the width of the slot, the combination of core member with surrounding loop-shaped provisions can not be pulled out of the channel of the respective guide.

In one embodiment of the sunshade assembly according to the present invention, the core member is a solid cylindrical member, such as for example a rod. The opposite ends of the rod may be attached to the same part of the vehicle as the guides, for example the fixed roof of the vehicle. The core member may be flexible.

In a further embodiment of the sunshade assembly according to the present invention, all of the loop-shaped provisions of a lateral edge are combined as one tunnel-shaped provision. Thus, in this embodiment, the lateral edges of the sunshade screen do not comprise a succession of separate loop-shaped provisions, but each only one tunnel-shaped provision which, in most cases, will extend along the entire length of the sunshade screen.

When, in accordance with the above, loop-shaped provisions (such as a tunnel-shaped provision) are provided at each lateral edge of the sunshade screen, it is possible that the sunshade screen is folded back on to itself (and attached in any appropriate manner) at said lateral edges for defining said loop-shaped provisions for receiving the core members.

In accordance with a second aspect of the present invention there is provided a vehicle, comprising a sunshade assembly in accordance with the present invention.

### BRIEF DESCRIPTION OF THE DRAWINGS

Hereinafter the invention will be elucidated referring to the drawing, in which, schematically, a transverse section is shown of a part of an open roof construction of a vehicle, provided with a sunshade assembly according to the present invention.

### DETAILED DESCRIPTION OF ILLUSTRATIVE EMBODIMENT

Referring to the drawing, an open roof construction is illustrated for a vehicle represented herein by a fixed roof 1 in which a roof opening 2 is provided. In a manner known per se, and not explained in detail here, a roof panel 3 is movable relative to the roof opening 2 for opening and closing the latter. Means or mechanisms for driving and guiding said roof panel 3 are not relevant for the present invention, and thus are not shown.

Below the roof opening 2, the open roof construction or sunshade assembly is provided. Basically, this sunshade assembly comprises a flexible sunshade screen 4 and two spaced, parallel guides 5 for receiving and guiding two parallel lateral edges of the sunshade screen 4.

Each guide 5 comprises a longitudinal channel 6, which opens towards the sunshade screen 4 through a longitudinal slot 7. In the channel 6, a core member 8 is positioned, which may be flexible.

As is clearly visible in the drawing, the guide 5 is attached to the fixed roof 1; the same may apply for the core member 8.

The core member 8 is positioned such in the channel 6 that between this core member 8 and the surrounding guide 5, a space 9 is defined with a function to be explained later.

At its two parallel lateral edges illustrated left and right in the drawing, the sunshade screen 4 is folded back onto itself for defining tunnel-shaped or looped-shaped provisions 10. In one embodiment, these tunnel-shaped provisions to extend (perpendicularly to the drawing) along the entire length of the sunshade screen 4.

The tunnel-shaped provisions 10 surround the core member 8 and thus extend longitudinally in the space 9 defined between the core member 8 and surrounding guide 5.

The tunnel-shaped provisions 10 can surround the core member 8 with a wide or loose fit (as shown at the left-handed side of the drawing), such that a sliding movement of the sunshade screen 4 relative to the guide 5 and core member 8 within the space 9 is possible in an easy manner.

The guides 5 are dimensioned such that the combined width D of the core member 8 and tunnel-shaped provision 10 when tightened around said core member 8 (as shown at the right-handed side of the drawing) is larger then the width d of the slot 7 of the guides 5. Thus it is impossible that the lateral edges of the sunshade screen 4 can be pulled out of the channel 6 of the guides 5, for example when, for moving the sunshade screen 4, an eccentric force is created by manually engaging a grip 11 attached to the sunshade screen 4, or when wind pressure P acts on the sunshade screen 4.

Although the present invention has been described with reference to particular embodiments, workers skilled in the art will recognize that changes may be made in form and detail without departing from the spirit and scope of the invention.

What is claimed is:

1. A sunshade assembly for use in an open roof construction in a vehicle, comprising:
a flexible sunshade screen having two parallel lateral edges, each of said lateral edges of the sunshade screen having loop-shaped provisions;
two spaced, parallel guides for receiving and guiding the two parallel lateral edges of the sunshade screen, wherein each guide includes a longitudinal channel that opens towards the sunshade screen through a longitudinal slot; and
a core member positioned in each channel and extending therein such that between the core member and the surrounding guide, a space is defined for slidingly receiving the loop-shaped provisions, and wherein each of the slots has a width which is smaller than the combined width of the core member with surrounding loop-shaped provisions.

2. The sunshade assembly according to claim 1, wherein the core member is a cylindrical member.

3. The sunshade assembly according to claim 2, wherein all of the loop-shaped provisions of a lateral edge are combined as one tunnel-shaped provision.

4. The sunshade assembly according to claim 1, wherein all of the loop-shaped provisions of a lateral edge are combined as one tunnel-shaped provision.

5. The sunshade assembly according to claim 1, wherein the sunshade screen is folded back onto itself at said lateral edges for defining said loop-shaped provisions for receiving the corresponding core member.

6. The sunshade assembly according to claim 2, wherein the sunshade screen is folded back onto itself at said lateral edges for defining said loop-shaped provisions for receiving the corresponding core member.

7. The sunshade assembly according to claim 3, wherein the sunshade screen is folded back onto itself at said lateral edges for defining said loop-shaped provisions for receiving the corresponding core member.

8. The sunshade assembly according to claim 4, wherein the sunshade screen is folded back onto itself at said lateral edges for defining said loop-shaped provisions for receiving the corresponding core member.

9. A vehicle, comprising:
a fixed roof; and
a sunshade assembly including:
a flexible sunshade screen having two parallel lateral edges, each of said lateral edges of the sunshade screen having loop-shaped provisions;
two spaced, parallel guides attached to the fixed roof for receiving and guiding the two parallel lateral edges of the sunshade screen, wherein each guide includes a longitudinal channel that opens towards the sunshade screen through a longitudinal slot; and
a core member positioned in each channel and extending therein such that between the core member and the surrounding guide, a space is defined for slidingly receiving the loop-shaped provisions, and wherein each of the slots has a width which is smaller than the combined width of the core member with surrounding loop-shaped provisions.

10. The vehicle according to claim 9, wherein the core member is a cylindrical member.

11. The vehicle according to claim 10, wherein all of the loop-shaped provisions of a lateral edge are combined as one tunnel-shaped provision.

12. The vehicle according to claim 9, wherein all of the loop-shaped provisions of a lateral edge are combined as one tunnel-shaped provision.

13. The vehicle according to claim 12, wherein the sunshade screen is folded back onto itself at said lateral edges for defining said loop-shaped provisions for receiving the corresponding core member.

14. The vehicle according to claim 9, wherein the sunshade screen is folded back onto itself at said lateral edges for defining said loop-shaped provisions for receiving the corresponding core member.

15. The vehicle according to claim 11, wherein the sunshade screen is folded back onto itself at said lateral edges for defining said loop-shaped provisions for receiving the corresponding core member.

16. The vehicle according to claim 10, wherein the sunshade screen is folded back onto itself at said lateral edges for defining said loop-shaped provisions for receiving the corresponding core member.
